(19) United States
(12) Patent Application Publication
(10) Pub. No.: US 2026/0277592 A1
(43) Pub. Date: Sep. 17, 2026

(54) ARCHITECTURE AND METHOD FOR BIOS UPDATE AND RECOVERY

(71) Applicant: Aivres Systems Inc., Fremont, CA (US)

(72) Inventor: Kai-Wei CHANG, New Taipei City (TW)

(21) Appl. No.: 19/670,473

(22) Filed: May 7, 2026

(51) Int. Cl. G06F 8/65

(52) U.S. Cl. CPC G06F 8/65

(57) ABSTRACT

A computing system includes a boot firmware memory, a host processor, a management controller, an auxiliary storage storing a recovery firmware image, and a switchable communication path coupled to the boot firmware memory, the host processor, and the management controller. The management controller detects a boot failure during a boot process, actuates the switchable communication path to switch access to the boot firmware memory from the host processor to the management controller, writes the recovery firmware image from the auxiliary storage to the boot firmware memory, restores access to the boot firmware memory to the host processor, and causes the computing system to restart such that the host processor boots using the recovery firmware image written to the boot firmware memory.

### TECHNICAL FIELD

The present disclosure relates to firmware recovery for computing systems and, more particularly, to controller-assisted restoration of boot firmware in response to a boot failure.

### BACKGROUND

Boot firmware is used to initialize hardware and support startup of a computing system. If the boot firmware stored in a boot firmware memory becomes corrupted, incomplete, or otherwise unusable, the host processor may be unable to complete the boot process. In many existing systems, recovery from such a condition requires manual intervention to rewrite the boot firmware memory, resulting in system downtime and increased maintenance burden.

Some systems employ redundant firmware storage, such as dual flash devices, so that a system may attempt to boot from a backup firmware device when a primary firmware device fails. However, such approaches can increase hardware cost, board complexity, and routing overhead. In addition, maintaining multiple boot-capable firmware copies may create synchronization, update management, and fault diagnosis challenges.

Accordingly, there is a need for an improved firmware recovery technique that enables automatic restoration of boot firmware after a boot failure while reducing dependence on redundant boot firmware devices.

### SUMMARY

A system of one or more computers can be configured to perform particular operations or actions by virtue of having software, firmware, hardware, or a combination thereof installed on the system that, in operation, causes the system to perform the actions. One or more computer programs can be configured to perform particular operations or actions by virtue of including instructions that, when executed by data processing apparatus, cause the apparatus to perform the actions.

In one general aspect, a computing system may include a boot firmware memory having a firmware image, a host processor configured to access the boot firmware memory during a boot process of the computing system using the firmware image, a management controller, an auxiliary storage accessible to the management controller having a recovery firmware image, and a switchable communication path coupled to the boot firmware memory, the host processor, and the management controller. The management controller is configured to, in response to a boot failure of the computing system during the boot process, control the switchable communication path and write the recovery firmware image from the auxiliary storage into the boot firmware memory to recover the computing system. Other embodiments of this aspect include corresponding computer systems, apparatus, and computer programs recorded on one or more computer storage devices, each configured to perform the actions of the methods.

Implementations may include one or more of the following features. To recover the computing system, the management controller is configured to: in response to a boot failure during the boot process, actuate the switchable communication path to switch access to the boot firmware memory from the host processor to the management controller; write the recovery firmware image from the auxiliary storage to the boot firmware memory; restore access to the boot firmware memory to the host processor via the switchable communication path; and cause the computing system to restart such that the host processor boots using the recovery firmware image written to the boot firmware memory.

The auxiliary storage is inaccessible directly by the host processor. The switchable communication path is configured to selectively couple the management controller to the boot firmware memory such that the management controller writes to the boot firmware memory using the recovery firmware image stored in the auxiliary storage. The auxiliary storage may include a hot-pluggable storage medium.

The management controller may include a local memory. To write the recovery firmware image from the auxiliary storage to the boot firmware memory, the management controller is configured to read the recovery firmware image from the auxiliary storage into the local memory, and then write the recovery firmware image from the local memory to the boot firmware memory. The management controller is further configured to enable an access channel between the host processor and the local memory, allowing the host processor to read the recovery firmware image directly from the local memory to boot the computing system. The booting of the computing system by the host processor using the recovery firmware image from the local memory and the writing of the recovery firmware image from the local memory to the boot firmware memory may occur in parallel.

The management controller is further configured to detect the boot failure by evaluating one or more boot-progress indicators, including a power-on self-test (POST) completion status, an observed POST code, or a watchdog timer timeout. The switchable communication path may include a multiplexer, and actuating the switchable communication path may include electrically isolating a host processor bus from the boot firmware memory and coupling a management controller bus to the boot firmware memory. The auxiliary storage and the boot firmware memory store different respective copies of firmware, with the recovery firmware image in the auxiliary storage being used by the management controller to restore the firmware image in the boot firmware memory after a boot failure. The management controller is further configured to verify the recovery firmware image written to the boot firmware memory by reading back data and comparing it with the corresponding data of the recovery firmware image. Implementations of the described techniques may include hardware, a method or process, or a computer-readable tangible medium.

In one general aspect, a method may include, in response to a boot failure of the computing system during a boot process, actuating, by a management controller, the switchable communication path to route access to the boot firmware memory from the host processor to the management controller. The method may also include writing, by the management controller, the recovery firmware image from the auxiliary storage to the boot firmware memory, and restoring, by the management controller, access to the boot firmware memory from the management controller to the host processor via the switchable communication path. The method may further include causing, by the management controller, the computing system to restart such that the host processor boots using the recovery firmware image written to the boot firmware memory. Other embodiments of this aspect include corresponding computer systems, apparatus, and computer programs recorded on one or more computer storage devices, each configured to perform the actions of the methods.

In one general aspect, a management controller is configured to, in response to a boot failure of the computing system during the boot process, actuate the switchable communication path to route access to the boot firmware memory from the host processor to the management controller, write the recovery firmware image from the auxiliary storage to the boot firmware memory, restore access to the boot firmware memory from the management controller to the host processor via the switchable communication path, and cause the computing system to restart such that the host processor boots using the recovery firmware image written to the boot firmware memory. Other embodiments of this aspect include corresponding computer systems, apparatus, and computer programs recorded on one or more computer storage devices, each configured to perform the actions of the methods.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1A illustrates an example dual-flash boot firmware architecture including a Central Processing Unit (CPU), a BMC, a chip-select mechanism, and multiple boot firmware flash devices, in accordance with some embodiments.

FIG. 1B illustrates an example boot recovery flow for the dual-flash architecture of FIG. 1A, including BIOS POST monitoring, watchdog evaluation, and switching to a spare flash device upon a boot failure condition, in accordance with some embodiments.

FIG. 2A illustrates an example computing-system architecture including a CPU, a BMC, an SPI multiplexer, and a boot firmware memory, in which the BMC selectively obtains access to the boot firmware memory through the SPI multiplexer, in accordance with some embodiments.

FIG. 2B illustrates an example firmware recovery and update architecture in which a BMC reads a recovery firmware image into BMC RAM, controls an SPI multiplexer, and communicates with a boot firmware memory and a network source, in accordance with some embodiments.

FIG. 3 illustrates an example process for BIOS recovery or update, including reading a BIOS image from auxiliary storage, switching an SPI multiplexer, writing the image to a boot firmware memory, performing error checking, retrying write operations, and generating a log and error report upon failure, in accordance with some embodiments.

FIG. 4 illustrates an example parallel recovery process in response to a boot failure, including a first track in which a BMC rewrites a boot firmware memory and a second track in which a host processor boots using a recovery firmware image provided from BMC local memory, in accordance with some embodiments.

FIG. 5 illustrates an example asynchronous update process in which a BMC receives an updated recovery firmware image, verifies the updated image, and writes the updated image to auxiliary storage independently of host-processor boot operations, in accordance with some embodiments.

FIG. 6 illustrates a block diagram of an example computer system in which various of the embodiments described herein may be implemented.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

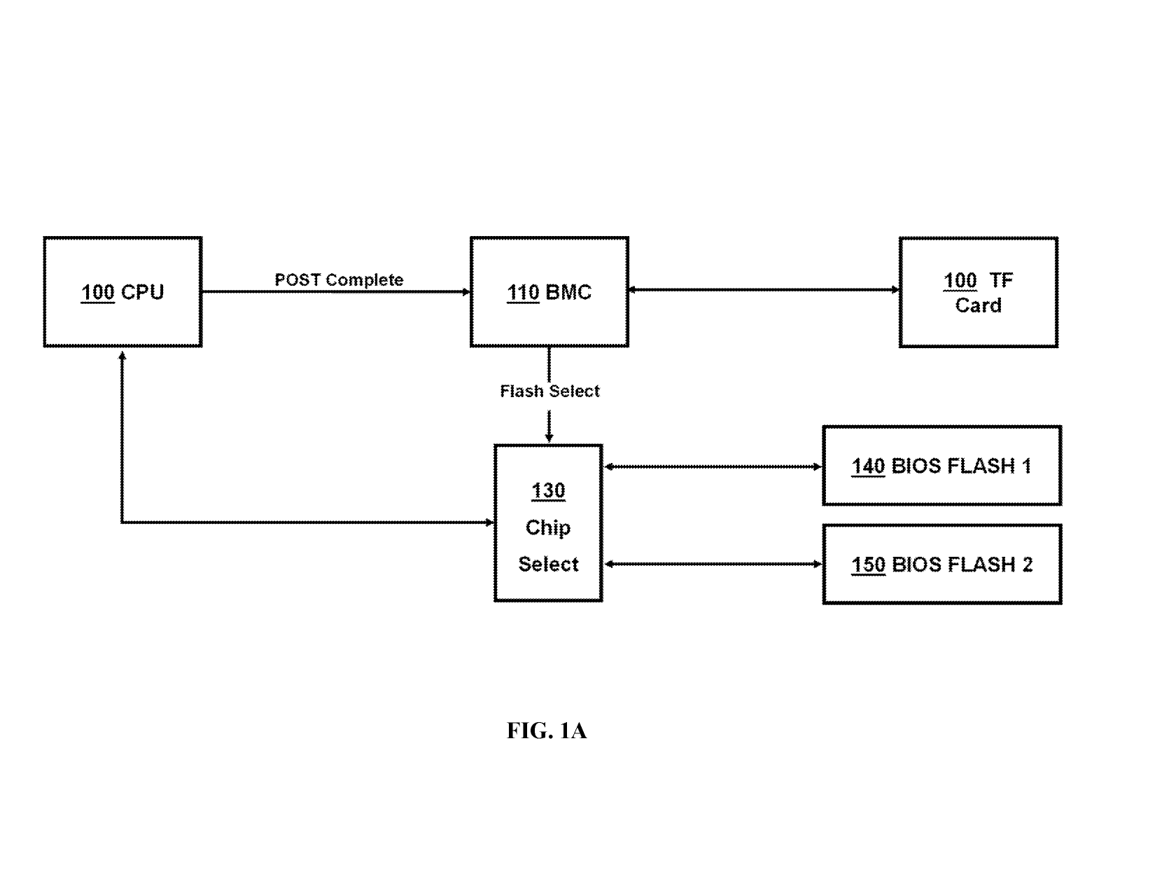

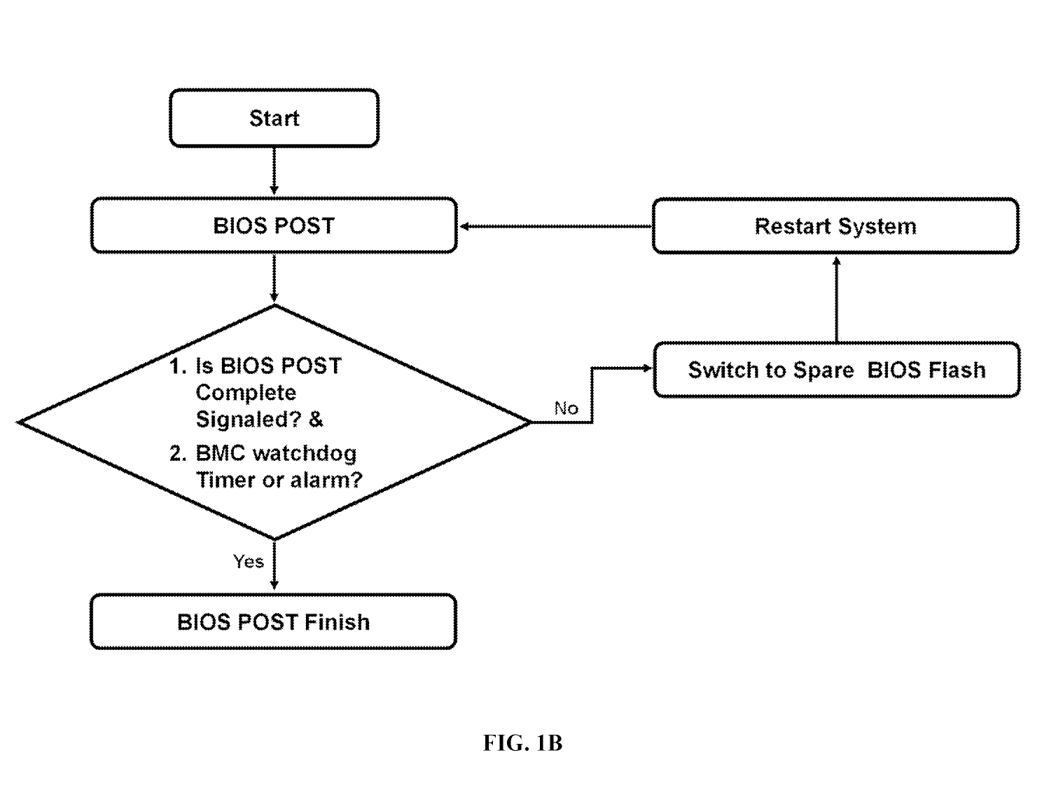

FIG. 1A illustrates an example dual-flash boot firmware architecture including a CPU 100, a BMC 110, a TF card 120, a chip-select circuit 130, a first BIOS flash 140, and a second BIOS flash 150, in accordance with some embodiments.

In a practical computing system, such as a server or other motherboard-based platform, the CPU 100 begins startup by fetching and executing boot firmware stored in nonvolatile memory. The boot firmware may be implemented as BIOS firmware or UEFI firmware and is responsible for early hardware initialization, basic platform configuration, device discovery, memory initialization, and transfer of control to a later-stage bootloader or operating system. A BMC 110 is typically an out-of-band management controller that remains available independently of the host operating system and may be used for platform monitoring, remote management, firmware maintenance, logging, and service operations. Public BMC documentation reflects that BMCs are commonly used for hardware monitoring, remote management, and firmware update operations.

During startup, the CPU 100 executes the BIOS firmware from whichever BIOS flash device is currently selected through chip select 130. As part of that startup, the BIOS performs a power-on self-test (POST). POST is an initialization and diagnostic sequence used to bring the platform into an operational state and to determine whether the system can continue booting. If the BIOS successfully reaches a designated checkpoint, such as the completion of POST or another defined successful-boot stage, the system outputs a POST-complete indication to the BMC 110. In some implementations, the POST-complete indication may be sent through a GPIO signal line or another hardware signal path. Accordingly, the POST-complete signal in FIG. 1A represents an indication that the boot firmware running on the CPU 100 has progressed far enough for the BMC 110 to treat the current boot attempt as successful.

The BMC 110 may monitor for receipt of the POST-complete signal within a predefined period, for example by using or supervising a watchdog timer. If the BMC 110 receives the POST-complete signal before expiration of the timer or other monitoring interval, the BMC 110 determines that the system has booted successfully from the currently selected BIOS flash. If the POST-complete signal is not received within the expected interval, the BMC 110 determines that the boot attempt has failed. In practice, such a failure may occur because the firmware image in the selected BIOS flash is corrupted, incomplete, incompatible with the platform state, or otherwise unable to complete POST.

After determining that boot has failed, the BMC 110 may control chip select 130 to change which BIOS flash device is presented to the CPU 100 for a subsequent boot attempt. For example, if BIOS FLASH 1 140 was selected during the failed boot attempt, the BMC 110 may actuate chip select 130 so that BIOS FLASH 2150 becomes selected for the next restart. The system can then be restarted, and the CPU 100 attempts to boot from the alternate BIOS flash device. In this manner, the dual-flash architecture uses multiple boot-capable flash devices and a selection mechanism to provide failover recovery when one firmware image does not successfully complete boot.

In architectures of this type, BIOS FLASH 1140 and BIOS FLASH 2150 are both intended to be boot-capable host firmware devices. As a practical matter, the contents of the two flash devices are therefore commonly maintained in a sufficiently compatible state so that, when failover occurs, the alternate flash can still support platform startup. This maintenance model can introduce update-management complexity because multiple boot-capable firmware copies may need to be coordinated. In commercial server environments, firmware update tools commonly support out-of-band update workflows through the BMC or Redfish, but vendor materials also indicate that firmware updates are managed operations that typically involve controlled sequencing and, in many cases, restart or reset actions before the updated firmware becomes active.

FIG. 1A also shows TF card 120 coupled to the BMC 110. In recent server and embedded-management designs, controller-side auxiliary storage, including removable or serviceable media and other nonvolatile storage resources, may be provided for management-related purposes rather than as the primary host boot source. By way of example, BMC-accessible storage resources may be used to retain management data, store diagnostic information or dumps, support backup or restore operations, or otherwise assist service and provisioning workflows.

Nevertheless, despite the availability of such BMC-side storage resources, dual-flash architectures of the type shown in FIG. 1A are still used for BIOS boot-failure recovery by maintaining multiple boot-capable BIOS flash devices and switching the host boot source from one device to another when a boot failure is detected. Thus, the practical operating logic of FIG. 1A is that the CPU 100 attempts to boot from a selected BIOS flash, the BMC 110 monitors whether POST successfully completes, and, if POST does not complete in time, the BMC 110 causes chip select 130 to switch the CPU 100 to another BIOS flash device for a subsequent boot attempt.

FIG. 1B illustrates an example boot recovery flow for the dual-flash architecture of FIG. 1A, including BIOS POST monitoring, watchdog evaluation, and switching to a spare flash device upon a boot failure condition, in accordance with some embodiments. As shown, after system start, the platform enters BIOS POST. The BMC monitors whether a BIOS POST-complete indication is received and whether a watchdog timer expires. If BIOS POST completes successfully and the watchdog timer does not alarm, the boot process is treated as successful and BIOS POST finishes. If the POST-complete indication is not received in time, or the watchdog timer indicates a timeout condition, the BMC determines that the current boot attempt has failed. In response, the system switches to a spare BIOS flash device and restarts the system so that another boot attempt is made from the spare flash.

FIG. 1B also illustrates several technical limitations of this recovery approach. First, recovery depends on maintaining a second boot-capable BIOS flash as a standby resource for failover. Second, because the spare BIOS flash is itself used as an alternate boot source, its firmware image is desirably maintained in sync with the firmware image in the primary BIOS flash, which requires updating them both at the same time (e.g., causing system down time). Third, the recovery mechanism is based on source switching between multiple host boot flash devices, rather than restoration of the failed boot firmware memory itself. As discussed below, certain embodiments of the present disclosure address these limitations by using controller-accessible auxiliary storage as a recovery-image source and by restoring a boot firmware memory under management-controller control, thereby reducing reliance on dual boot-capable flash devices for boot-failure recovery.

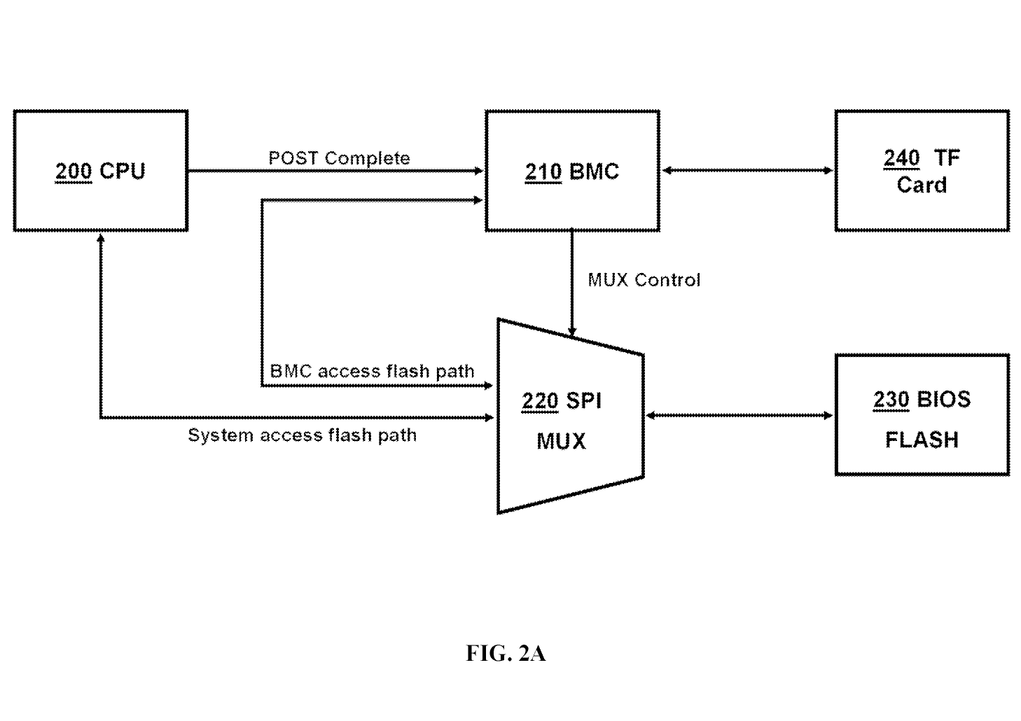

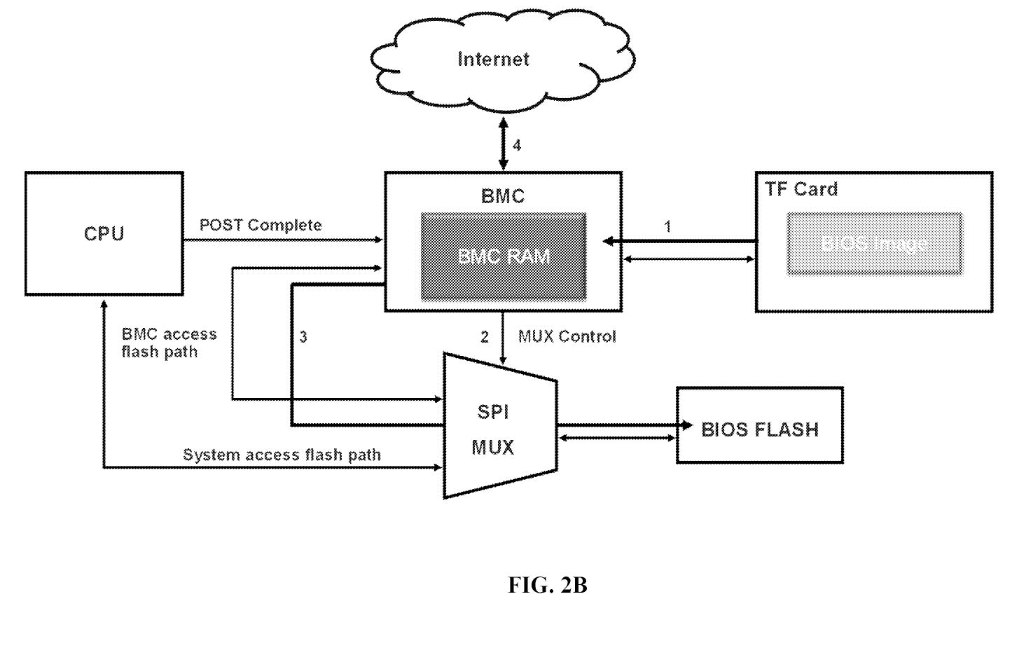

FIG. 2A illustrates an example computing-system architecture including a CPU 200, a BMC 210, a Serial Peripheral Interface (SPI) multiplexer (MUX) 220, a BIOS flash 230, and a TF card 240, in accordance with some embodiments. In the illustrated arrangement, CPU 200 is a host processor of the computing system and BIOS flash 230 is a non-volatile memory (also called boot firmware memory) storing a firmware image used by CPU 200 during a boot process of the computing system. BMC 210 is a management controller that operates independently of successful completion of the host boot process and is configured to monitor system boot status and to perform firmware-recovery operations when a boot failure is detected.

In some embodiments, BIOS flash 230 stores a BIOS image, a UEFI image, or another boot firmware image used by CPU 200 to initialize platform hardware during startup. During normal operation, CPU 200 accesses BIOS flash 230 through a system access flash path, as shown in FIG. 2A. BMC 210 receives a POST Complete indication from CPU 200, which may represent successful completion of POST or another designated boot-progress checkpoint. BMC 210 may use the POST Complete indication, alone or in combination with one or more additional boot-progress indicators, to determine whether the boot process has completed successfully. By way of example, the boot-progress indicators may include POST completion status, one or more observed POST codes, watchdog timeout status, or combinations thereof.

In the example of FIG. 2A, SPI MUX 220 provides a switchable communication path coupled to BIOS flash 230, CPU 200, and BMC 210. More specifically, SPI MUX 220 selectively connects BIOS flash 230 to either the system access flash path associated with CPU 200 or the BMC access flash path associated with BMC 210. A MUX control signal generated by BMC 210 controls which access path is active. In some embodiments, when the computing system is operating normally, SPI MUX 220 couples BIOS flash 230 to CPU 200 so that CPU 200 reads the firmware image from BIOS flash 230 during the boot process. When BMC 210 detects a boot failure, BMC 210 actuates SPI MUX 220 to switch access to BIOS flash 230 from CPU 200 to BMC 210. As used herein, “switching” access encompasses both direct switching (i.e., transitioning directly from the CPU access path to the BMC access path, or vice versa) and indirect switching involving one or more intermediate states. For example, an indirect switch may include temporarily transitioning the communication path to a high-impedance, disconnected, or floating state before establishing the coupling to the intended access path. In this switched state, CPU 200 is electrically isolated from BIOS flash 230, and BMC 210 is coupled to BIOS flash 230 for direct read and write access. Thus, SPI MUX 220 may be implemented as a multiplexer that selectively couples the management-controller side or the host-processor side to the boot firmware memory.

TF card 240 is an example of auxiliary storage accessible to BMC 210. In some embodiments, TF card 240 stores a recovery firmware image that is distinct from the firmware image currently stored in BIOS flash 230. The recovery firmware image may be a complete BIOS image, a complete UEFI image, or another restorable firmware image suitable for reprogramming BIOS flash 230. In other embodiments, TF card 240 stores the same firmware image as the firmware image currently stored in the BIOS flash 230.

As shown in FIG. 2A, TF card 240 is coupled to BMC 210 and is not directly connected to CPU 200. Accordingly, in some embodiments, the auxiliary storage is accessible to BMC 210 but inaccessible directly by CPU 200. This arrangement allows BMC 210 to manage the recovery firmware image independently of host-processor access to BIOS flash 230.

In some embodiments, TF card 240 is a removable storage medium, such as a microSD or TF storage card, and may be hot pluggable. As used herein, hot pluggable means that the auxiliary storage medium may be inserted, removed, replaced, or serviced without requiring replacement of BIOS flash 230 and, in some implementations, without requiring disassembly or direct service of the host boot firmware memory path.

The use of such auxiliary storage provides a controller-side repository for a recovery firmware image and allows the recovery firmware image to be provisioned, refreshed, or replaced separately from the firmware image currently stored in BIOS flash 230. In some embodiments, the recovery firmware image may be preloaded on TF card 240 before deployment of the computing system. In some embodiments, TF card 240 may be updated during servicing. In some embodiments, BMC 210 may obtain an updated recovery image through a network interface and store the updated recovery image in TF card 240 for later use in a firmware-recovery operation.

In operation, FIG. 2A shows a single boot firmware memory architecture in which BIOS flash 230 is the flash memory from which CPU 200 boots during normal startup, while TF card 240 serves as an auxiliary storage resource holding a recovery firmware image for controller-initiated restoration of BIOS flash 230. This differs from a dual-flash architecture of FIG. 1A in which two separate boot-capable BIOS flash devices are maintained as alternate host boot sources. In the illustrated architecture of FIG. 2A, the recovery operation is performed by causing BMC 210 to obtain access to BIOS flash 230 through SPI MUX 220 and rewrite BIOS flash 230 using the recovery firmware image stored in TF card 240.

FIG. 2B illustrates a further example of the architecture of FIG. 2A, in accordance with some embodiments. FIG. 2B additionally shows BMC RAM within BMC 210 and illustrates example data and control flows associated with a recovery operation. In some embodiments, BMC RAM is a local memory of BMC 210 and may include volatile memory, such as RAM, used as a staging area for the recovery firmware image. As indicated by arrow 1 in FIG. 2B, BMC 210 reads the BIOS image from TF card 240 into BMC RAM. In some embodiments, BMC 210 copies the entire recovery firmware image into BMC RAM before beginning a write operation to BIOS flash 230. In some embodiments, BMC 210 may instead load the recovery firmware image into BMC RAM in blocks, segments, pages, or streaming portions suitable for later writeback to BIOS flash 230.

As indicated by arrow 2 in FIG. 2B, BMC 210 controls SPI MUX 220 through the MUX control signal so as to switch the flash-access path from the host side (i.e., the CPU) to the BMC side. Once SPI MUX 220 has coupled BMC 210 to BIOS flash 230, BMC 210 can write the recovery firmware image from BMC RAM to BIOS flash 230. In some embodiments, arrow 3 represents controller-side data movement associated with the restore operation, including transfer of the recovery firmware image from BMC RAM through SPI MUX 220 to BIOS flash 230 and, in some embodiments, read-back of written data for verification. After completion of the write operation, BMC 210 may actuate SPI MUX 220 again to restore the system access flash path to CPU 200, and BMC 210 may cause the computing system to restart so that CPU 200 boots using the recovery firmware image written to BIOS flash 230.

In some embodiments, BMC 210 verifies that BIOS flash 230 has been successfully rewritten. Such verification may be performed by reading back data from BIOS flash 230 after writing and comparing the read-back data with corresponding data of the recovery firmware image stored in BMC RAM, TF card 240, or another controller-accessible source. Verification may be performed on a full-image basis or on a partial basis, such as by block, sector, page, region, checksum, hash, signature, or another comparison metric. If a mismatch is detected, BMC 210 may repeat one or more write operations for the affected portion, repeat the write sequence for the full image, or perform another recovery-handling procedure.

In some embodiments, the diagram in FIG. 2B may be adjusted to implement an enhanced recovery mode in which BMC 210 enables an access channel between CPU 200 and BMC RAM, thereby allowing CPU 200 to access the recovery firmware image directly from BMC RAM for a boot attempt. In such embodiments, BMC RAM functions not only as a staging buffer for programming BIOS flash 230, but also as a temporary source from which CPU 200 can obtain boot firmware data. In some embodiments, CPU 200 may read the recovery firmware image from BMC RAM while BMC 210 also writes the recovery firmware image from BMC RAM into BIOS flash 230. This permits boot-retry activity and firmware-restoration activity to occur in parallel. For example, CPU 200 may begin booting using the image in BMC RAM while BMC 210 reprograms BIOS flash 230 in the background. Such parallel processing can reduce recovery latency and improve the efficiency of returning the system to an operational state.

In some embodiments, the direct access path between CPU 200 and BMC RAM may be established through a bus bridge, shared memory mapping, controller-mediated exposure of the image, or another access mechanism that allows CPU 200 to obtain firmware data from local memory of BMC 210. In some embodiments, this access channel is enabled only after BMC 210 detects a boot failure. In some embodiments, the access channel is transient and is disabled after BIOS flash 230 has been restored and the system has returned to normal boot operation from BIOS flash 230.

In some embodiments, enabling CPU 200 to obtain the recovery firmware image from BMC RAM can improve boot-retry performance because the read bandwidth of RAM is generally substantially higher than the read bandwidth of BIOS flash 230. By way of example, serial NOR flash devices commonly used for boot firmware storage may provide read throughput on the order of about 90 megabytes per second (MB/s) to about 400 MB/s, depending on interface mode and implementation, whereas platform RAM bandwidth is commonly on the order of multiple gigabytes per second (GB/s) and may reach tens of GB/s in representative systems. Thus, reading the recovery firmware image from BMC RAM may provide approximately one to two orders of magnitude higher read bandwidth than reading the recovery firmware image from BIOS flash 230. As a result, in embodiments in which CPU 200 accesses the recovery firmware image from BMC RAM for a boot attempt while BMC 210 writes the recovery firmware image into BIOS flash 230, overall recovery latency may be reduced and system restart efficiency may be improved.

In some embodiments, the recovery firmware image stored in TF card 240 and the firmware image stored in BIOS flash 230 are different respective copies of firmware. For example, BIOS flash 230 may initially contain a corrupted, outdated, incomplete, or otherwise unusable firmware image, while TF card 240 stores a valid recovery image maintained for restoration purposes. In some embodiments, the two images may be identical prior to a failure event. In some embodiments, the image in TF card 240 may be a newer image than the image in BIOS flash 230. In some embodiments, the image in TF card 240 may be selected by policy, version, platform compatibility, or recovery criteria enforced by BMC 210.

In some embodiments, BMC 210 may update or refresh the recovery firmware image stored in TF card 240 independently of the ordinary host boot path through BIOS flash 230. For example, as indicated by arrow 4 in FIG. 2B, BMC 210 may communicate with a remote network source, such as an update server, administrative system, or management network, to obtain a replacement or updated BIOS image. BMC 210 may then store that image in TF card 240 for later use as a recovery firmware image. Because TF card 240 is separate from BIOS flash 230 and is accessible on the management-controller side, image maintenance for the auxiliary storage may be performed separately from host access to BIOS flash 230. In some embodiments, this allows offline preparation of recovery media, pre-deployment staging of a recovery image, or controller-side updating of the auxiliary storage without immediate rewriting of BIOS flash 230.

Accordingly, FIGS. 2A and 2B illustrate a computing-system architecture in which BMC 210 monitors boot progress of CPU 200, determines whether a boot failure has occurred, selectively obtains access to BIOS flash 230 through SPI MUX 220, reads a recovery firmware image from auxiliary storage such as TF card 240, and restores BIOS flash 230 using the recovery firmware image. In some embodiments, BMC 210 stages the recovery firmware image in BMC RAM, verifies the write operation by read-back comparison, and optionally exposes the staged image to CPU 200 for direct boot access. The illustrated architecture thereby supports controller-mediated restoration of a boot firmware memory while using auxiliary storage as a recovery-image source separate from the boot firmware memory itself.

It will be appreciated that the particular components and interconnect arrangements shown in FIGS. 2A and 2B are illustrative examples and are not intended to limit the disclosed subject matter to the specific hardware implementation depicted. For example, SPI MUX 220 may be implemented using a Serial Peripheral Interface (SPI) multiplexer, switch, selector, bridge, gating circuit, bus-isolation circuit, or other controllable communication-path circuitry capable of selectively coupling a boot firmware memory to a host processor side or to a management-controller side. Likewise, although SPI is shown in the illustrated embodiments, other communication protocols, buses, or interfaces may be used where suitable for accessing a boot firmware memory or other nonvolatile firmware storage, including, by way of example, enhanced SPI (eSPI), quad SPI (QSPI), octal SPI (OSPI), embedded MultiMediaCard (eMMC), Universal Flash Storage (UFS), Inter-Integrated Circuit (I2C), or other serial, parallel, memory-mapped, or controller-accessible storage interfaces. Similarly, TF card 240 is one example of auxiliary storage and may be replaced with or implemented by another controller-accessible storage medium, such as a microSD card, Secure Digital (SD) card, embedded MultiMediaCard (eMMC) device, Universal Flash Storage (UFS) device, USB flash storage device, solid-state storage device, embedded nonvolatile memory, removable flash module, network-attached storage resource, or other local or remote storage suitable for storing a recovery firmware image. In the same manner, BIOS flash 230 may be implemented using any suitable boot firmware memory or nonvolatile storage device, and BMC 210 may be implemented by any suitable management controller, service processor, embedded controller, management SoC, programmable logic device, or other controller capable of performing the disclosed monitoring, switching, and firmware-recovery operations.

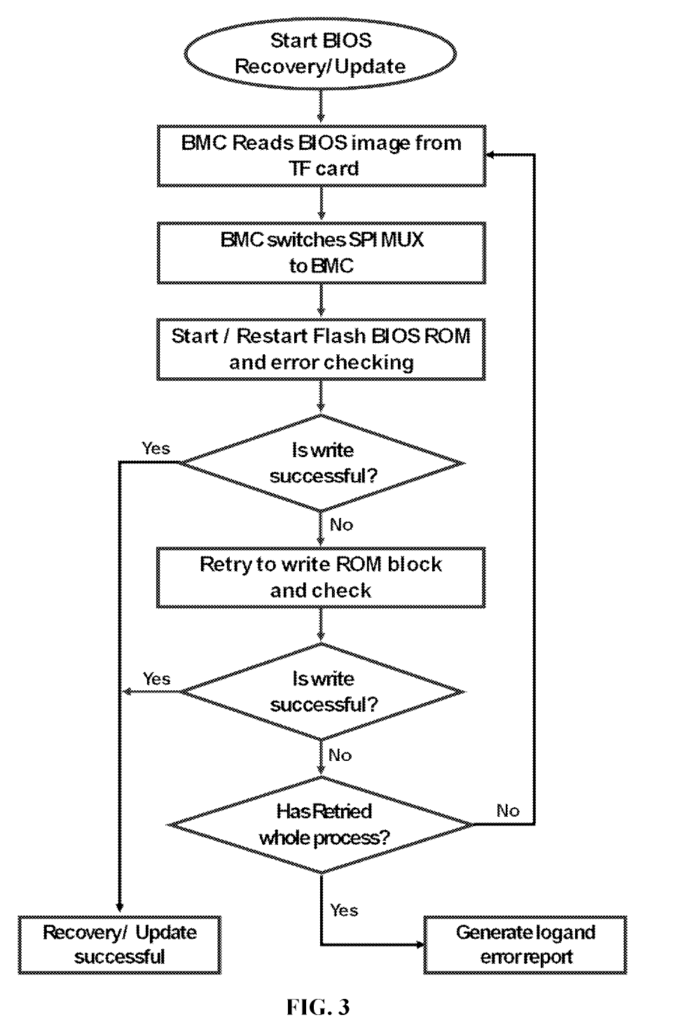

FIG. 3 illustrates an example process for BIOS recovery or update, including reading a BIOS image from auxiliary storage, switching an SPI multiplexer, writing the image to a boot firmware memory, performing error checking, retrying write operations, and generating a log and error report upon failure, in accordance with some embodiments. The process of FIG. 3 may be performed by a management controller, such as a BMC, in a computing system of the type described above with respect to FIGS. 2A and 2B. In some embodiments, the process is initiated after the management controller detects a boot failure of the computing system. In some embodiments, the process may additionally or alternatively be initiated as part of a firmware update operation, for example when a valid replacement BIOS image is available in auxiliary storage and a rewrite of the boot firmware memory is desired.

As shown in FIG. 3, the process begins with a start BIOS recovery/update operation (e.g., in response to a time-out in receiving the POST complete signal). The management controller reads a BIOS image from a TF card or other auxiliary storage. In some embodiments, the BIOS image read from the auxiliary storage is a recovery firmware image maintained separately from the firmware image currently stored in the boot firmware memory. In some embodiments, the management controller reads the BIOS image directly from the auxiliary storage and writes it to the boot firmware memory. In some embodiments, the management controller first stages the BIOS image in local memory, such as BMC RAM, before beginning the write operation.

After obtaining the BIOS image, the management controller switches the SPI MUX from system access to BMC access. In some embodiments, this operation transfers control of the boot firmware memory from the host processor side to the management-controller side. For example, the management controller may actuate a multiplexer or other switchable communication path so as to electrically isolate the host processor bus from the boot firmware memory and couple a management-controller bus to the boot firmware memory. Once this switching has occurred, the management controller has direct access to the boot firmware memory for programming operations.

The process then proceeds to start or restart flashing of the BIOS ROM together with error checking. In some embodiments, the management controller writes the BIOS image to the boot firmware memory in a sequence of blocks, sectors, pages, regions, or other writable portions. Error checking may be performed during and/or after the write operation. In some embodiments, error checking includes reading back written data from the boot firmware memory and comparing the read-back data with corresponding data of the BIOS image used as the write source. In some embodiments, the comparison may be performed on a block-by-block basis, page-by-page basis, checksum basis, hash basis, or other verification basis suitable for confirming that the intended firmware data has been successfully stored in the boot firmware memory.

The decision block labeled “Is successful to write?” represents evaluation of whether the write and associated checking have succeeded. If the write is successful, the recovery or update operation is treated as successful. In some embodiments, after successful completion of the write operation, the management controller restores access of the boot firmware memory from the BMC to the host processor by switching the communication path back to the system side (e.g., to the host processor). In embodiments involving boot-failure recovery, the management controller may further cause the computing system to restart such that the host processor boots using the firmware image written to the boot firmware memory.

If the write is not successful, the process proceeds to retry writing a ROM block and check again. In some embodiments, the management controller identifies an affected block, page, sector, or region for rewrite and repeats the write operation for that portion of the boot firmware memory. The management controller then performs another verification operation to determine whether the retry was successful. Accordingly, FIG. 3 illustrates that verification and retry may be performed iteratively at a sub-image granularity, rather than requiring immediate restart of the full process after a single detected error.

If the retry operation succeeds, the process may conclude with successful recovery or update. If the retry operation still does not succeed, the process proceeds to a determination of whether to retry the whole process. In some embodiments, this determination may depend on a retry counter, an error threshold, a type of failure, a policy setting, or another management criterion. If the whole process is to be retried, the flow returns to the BIOS-image read operation, and the management controller again reads the BIOS image from the TF card or other auxiliary storage and repeats the restoration sequence. In this manner, FIG. 3 illustrates that the management controller may restart the entire BIOS recovery/update flow after an unsuccessful write sequence.

If the management controller determines not to retry the whole process, the process proceeds to generation of a log and error report. In some embodiments, the log and error report may include information identifying the computing system, the time of failure, the affected boot firmware memory, the BIOS image version, the number of attempted retries, the type of error encountered, and the stage of the process at which failure occurred. In some embodiments, the log may be stored locally by the management controller. In some embodiments, the error report may be transmitted over a network to an administrator, service processor, management server, or monitoring platform. Thus, FIG. 3 illustrates not only controller-initiated restoration of a boot firmware memory from auxiliary storage, but also verification, localized retry, full-process retry, and failure reporting mechanisms that improve robustness of the recovery or update operation.

In some embodiments, the process of FIG. 3 may be used in a recovery context after boot failure detection based on one or more boot-progress indicators, such as POST completion status, POST code observation, or watchdog timeout. In some embodiments, the same process may be used in an update context even in the absence of a prior boot failure, for example to proactively refresh the boot firmware memory using an image stored in the auxiliary storage. Accordingly, FIG. 3 illustrates a controller-managed firmware rewrite flow that can be used for post-failure recovery and, in some implementations, for controlled BIOS update operations as well.

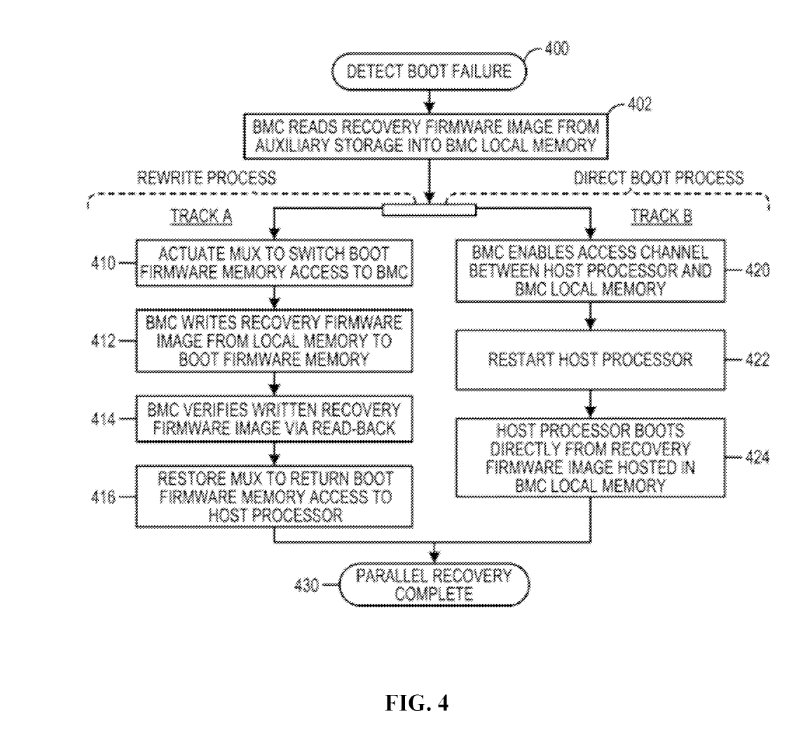

FIG. 4 illustrates an example parallel recovery process in response to a boot failure, including a first track in which a BMC rewrites a boot firmware memory and a second track in which a host processor boots using a recovery firmware image provided from BMC local memory, in accordance with some embodiments. The process may be performed after the management controller detects a boot failure at block 400. In some embodiments, the boot failure may be detected based on one or more boot-progress indicators, such as absence of a POST-complete indication, an observed POST code indicating an unsuccessful boot state, expiration of a watchdog timer, or a combination thereof.

At block 402, the BMC reads a recovery firmware image from auxiliary storage into BMC local memory. In some embodiments, the auxiliary storage may be a TF card or another controller-accessible storage medium storing a recovery firmware image separate from the firmware image currently stored in the boot firmware memory. The BMC local memory may be RAM or another memory local to the BMC and may function as a staging buffer for the recovery firmware image. In some embodiments, the BMC reads the recovery firmware image into the local memory before either the rewrite process or the direct-boot process begins. In some embodiments, the image may be loaded as a complete image. In some embodiments, the image may be loaded in portions, such as blocks, segments, pages, or regions, depending on implementation.

After the recovery firmware image is placed in BMC local memory, the process may proceed along two tracks, which may be carried out concurrently, partially concurrently, or in an overlapping manner. A first track, identified as Track A, is a rewrite process for restoring the boot firmware memory. A second track, identified as Track B, is a direct boot process in which the host processor uses the recovery firmware image hosted in the BMC local memory.

In Track A, at block 410, the BMC actuates a multiplexer to switch access to the boot firmware memory from the host processor side to the BMC side. In some embodiments, this operation selectively couples the BMC to the boot firmware memory while isolating the host-side flash path. After access has been switched, the BMC can directly program the boot firmware memory. At block 412, the BMC writes the recovery firmware image from the local memory to the boot firmware memory. In some embodiments, the writing may occur in units such as sectors, pages, or blocks. In some embodiments, the BMC writes the image sequentially across the boot firmware memory.

At block 414, the BMC verifies the written recovery firmware image via read-back. In some embodiments, verification includes reading data back from the boot firmware memory after writing and comparing the read-back data with corresponding data of the recovery firmware image stored in the BMC local memory. Verification may be performed for the complete image or on a partial basis, such as by block, region, checksum, signature, or hash. If desired, additional recovery handling may be performed when a mismatch is detected, such as rewriting an affected portion or repeating part or all of the restoration sequence. At block 416, after the write operation has been successfully completed, the BMC restores the multiplexer so that access to the boot firmware memory is returned to the host processor.

In Track B, at block 420, the BMC enables an access channel between the host processor and the BMC local memory. In some embodiments, the access channel may be established through a bus bridge, shared-memory mapping, controller-mediated exposure of the recovery firmware image, or another mechanism that allows the host processor to obtain firmware data from the BMC local memory. At block 422, the host processor is restarted or otherwise permitted to reinitiate boot processing. At block 424, the host processor boots directly from the recovery firmware image hosted in the BMC local memory. In this manner, the BMC local memory acts as a temporary firmware source for the host processor while the boot firmware memory is being restored.

As shown in FIG. 4, Track A and Track B may proceed in parallel. Thus, in some embodiments, while the BMC is writing the recovery firmware image from the BMC local memory to the boot firmware memory, the host processor may also read the recovery firmware image from the same BMC local memory for a boot attempt. This parallel operation can reduce recovery latency because the host processor need not wait for completion of the entire rewrite operation before beginning a boot retry. In addition, because the host processor is reading the recovery firmware image from local memory rather than from flash storage, recovery performance may be improved in implementations in which access to the BMC local memory provides higher read bandwidth than access to the boot firmware memory. The parallel recovery operation is indicated as complete at block 430.

In some embodiments, completion of the parallel recovery process means that the host processor has successfully resumed boot processing using the recovery firmware image in the BMC local memory and that the boot firmware memory has been restored with the recovery firmware image for subsequent normal boot operation. In some embodiments, after successful restoration of the boot firmware memory, the access channel between the host processor and the BMC local memory may be disabled, such that later boot operations proceed from the restored boot firmware memory rather than from the BMC local memory. In some embodiments, the direct-boot capability from the BMC local memory is enabled only in a recovery mode following detection of a boot failure.

In some embodiments, the arrangement shown in FIG. 4 provides a performance advantage relative to recovery techniques in which a host processor boots from a backup flash device after a boot failure. In the illustrated process, the recovery firmware image is first staged in BMC local memory and can then be used both as a source for rewriting the boot firmware memory and as a direct boot source for the host processor. This permits the rewrite process and the boot-retry process to overlap in time, thereby improving recovery efficiency and reducing overall time to resume operation.

In some embodiments, the process of FIG. 4 may be used with any suitable boot firmware image, including a BIOS image, a UEFI image, or another startup firmware image for the platform. In some embodiments, the BMC may select the recovery firmware image from among multiple images based on platform type, firmware version, policy, compatibility, or error condition. In some embodiments, the BMC local memory may hold one image or multiple images, and the access channel may expose one or more selected regions of the local memory to the host processor for boot use.

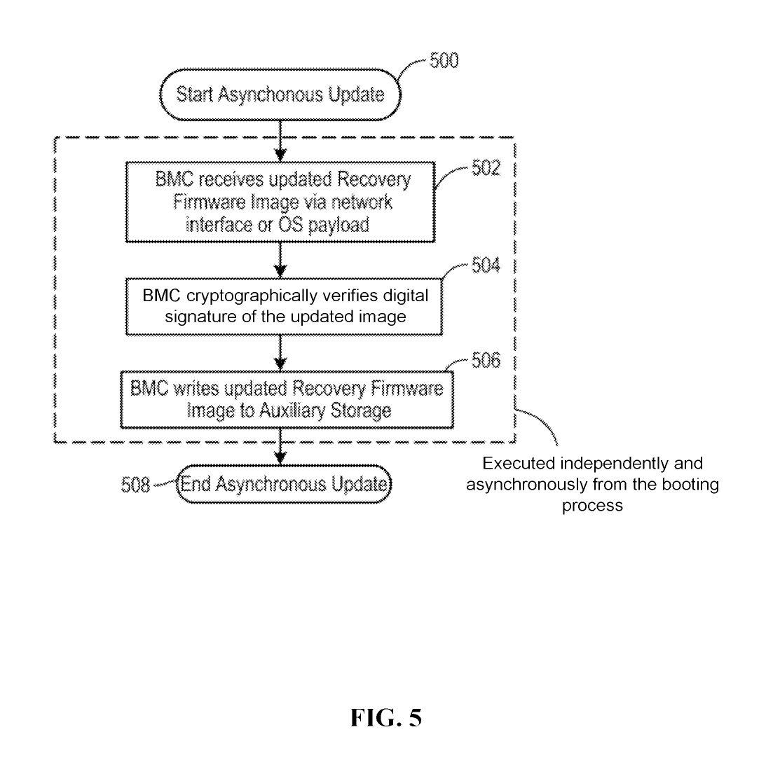

FIG. 5 illustrates an example asynchronous update process in which a BMC receives an updated recovery firmware image, verifies the updated image, and writes the updated image to auxiliary storage independently of host-processor boot operations, in accordance with some embodiments. The process of FIG. 5 may be performed by a management controller, such as a BMC, in order to maintain a current recovery firmware image in controller-accessible auxiliary storage for later use in a recovery operation. In some embodiments, the process is performed independently of whether the host processor is actively booting from the boot firmware memory. Thus, the process of FIG. 5 may be executed separately from the ordinary host boot path and separately from an immediate rewrite operation directed to the boot firmware memory.

At block 500, an asynchronous update operation begins. In some embodiments, the asynchronous update operation is initiated according to an update policy, an administrator command, a scheduled maintenance event, detection of an available firmware update, or another management condition. In some embodiments, the asynchronous update operation is initiated while the host processor remains in service. In some embodiments, the asynchronous update operation is initiated while the host processor is powered down, idle, or otherwise not engaged in a boot sequence. Accordingly, the process of FIG. 5 permits the recovery firmware image to be maintained on the management-controller side without requiring that the boot firmware memory be rewritten at the same time.

At block 502, the BMC receives an updated recovery firmware image via a network interface or an operating-system payload. In some embodiments, the updated recovery firmware image is obtained from a remote update server, a vendor server, an enterprise management platform, a local administrative system, or another network-accessible source. In some embodiments, the updated recovery firmware image is received from software executing on the host platform, such as an operating-system level update agent, service utility, firmware-delivery component, or other payload mechanism capable of delivering the updated image to the BMC. In some embodiments, the updated recovery firmware image may include a complete BIOS image, a complete UEFI image, or another boot firmware image suitable for later storage in auxiliary storage and later use as a recovery image.

At block 504, the BMC cryptographically verifies a digital signature of the updated image. In some embodiments, the verification operation includes validating a signature, certificate, manifest, hash value, message authentication code, or another authenticity or integrity indicator associated with the updated recovery firmware image. In some embodiments, the BMC performs this verification before accepting the updated image for storage in the auxiliary storage. In this manner, the management controller may ensure that the image written into the auxiliary storage is authenticated, uncorrupted, and suitable for later use in restoring the boot firmware memory. Although FIG. 5 shows digital-signature verification as one example, other validation or qualification operations may additionally or alternatively be performed, including version checks, platform compatibility checks, policy checks, rollback-prevention checks, or other image-acceptance criteria.

At block 506, after the updated image has been accepted, the BMC writes the updated recovery firmware image to auxiliary storage. In some embodiments, the auxiliary storage may be a TF card, microSD card, SD card, eMMC device, UFS device, removable flash module, or another local or remote storage resource accessible to the BMC. The updated recovery firmware image stored in the auxiliary storage may replace a prior recovery image or may be stored as one of multiple recovery images maintained in the auxiliary storage. In some embodiments, metadata associated with the updated recovery firmware image, such as version information, platform identification, checksum data, signature status, timestamp information, or update policy information, may also be stored.

At block 508, the asynchronous update process ends. As indicated in FIG. 5, the operations enclosed within the dashed boundary may be executed independently and asynchronously from host-processor booting operations. In some embodiments, this means that the BMC can receive, authenticate, and store an updated recovery firmware image in the auxiliary storage without requiring the host processor to immediately consume that image during boot and without requiring the boot firmware memory to be rewritten during the same operation. This arrangement allows the recovery image repository maintained on the management-controller side to be prepared, refreshed, or preconfigured in advance of an actual boot failure.

In some embodiments, the process of FIG. 5 provides a technical benefit in that maintenance of the recovery firmware image is decoupled from the active boot firmware path used by the host processor. For example, the boot firmware memory may continue to serve the host processor during normal operation, while the BMC separately updates the recovery firmware image stored in the auxiliary storage. As a result, the recovery image may be maintained asynchronously with respect to host booting operations and independently of any immediate rewrite of the boot firmware memory. This architecture differs from update approaches in which multiple boot-capable flash devices are maintained as alternate host boot sources and are updated under coordinated boot-firmware management constraints. In the arrangement shown in FIG. 5, the auxiliary storage functions as a controller-side recovery-image repository, and the update process refreshes that repository in preparation for a later recovery event.

In some embodiments, after the updated recovery firmware image has been stored in the auxiliary storage, the image may later be read by the BMC into local memory and written to the boot firmware memory in response to a detected boot failure, as described above with respect to other figures. In some embodiments, the updated recovery firmware image may also be selected by the BMC from among multiple available images according to platform type, firmware version, compatibility information, administrative policy, or security policy. Thus, FIG. 5 illustrates a management-controller-driven process for asynchronously provisioning and maintaining a recovery firmware image in auxiliary storage so that the image is available for later boot-failure recovery without requiring synchronous modification of the host boot path at the time of the update.

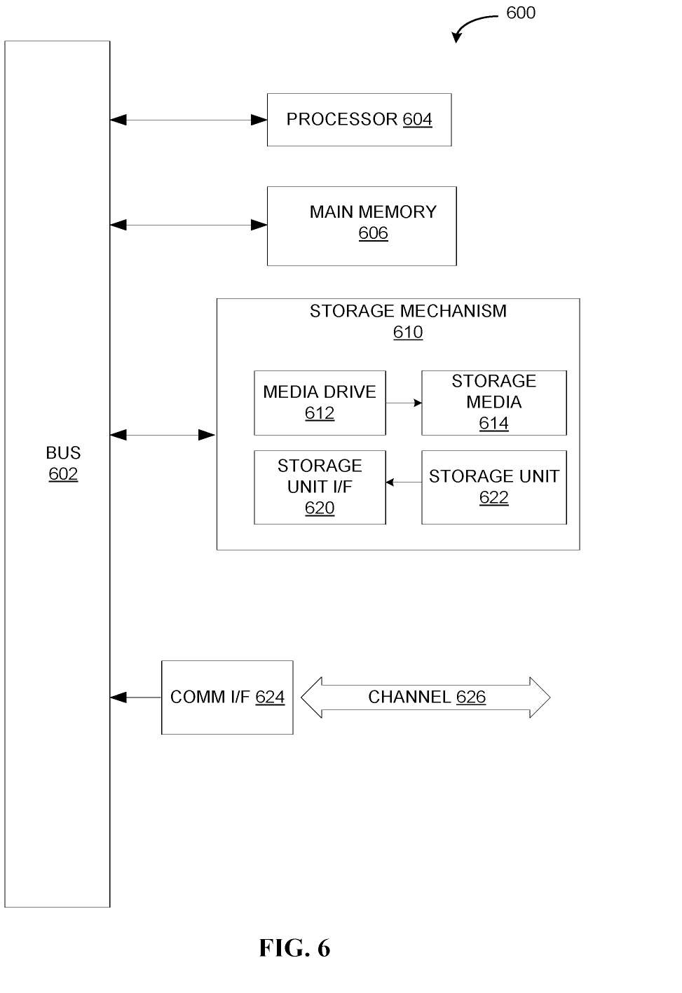

FIG. 6 illustrates an example computing system 600 that may be used in implementing various features of embodiments of the disclosed technology.

As used herein, the term module may describe a given unit of functionality that can be performed in accordance with one or more embodiments of the present application. As used herein, a module may be implemented utilizing any form of hardware, software, or a combination thereof. For example, one or more processors, controllers, ASICs, PLAs, PALs, CPLDs, FPGAs, logical components, software routines or other mechanisms may be implemented to make up a module. In implementation, the various modules described herein may be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 600. After reading this description, it will become apparent to a person skilled in the relevant art how to implement the application using other computing modules or architectures.

Referring now to FIG. 6, computing module 600 may represent, for example, computing or processing capabilities found within desktop, laptop, notebook, tablet, cloud and edge, computers; hand-held computing devices (tablets, PDA’s, smart phones, cell phones, palmtops, etc.); mainframes, supercomputers, workstations or servers; or any other type of special-purpose or general-purpose computing devices as may be desirable or appropriate for a given application or environment. Computing module 600 may also represent computing capabilities embedded within or otherwise available to a given device. For example, a computing module may be found in other electronic devices such as, for example, digital cameras, navigation systems, cellular telephones, portable computing devices, modems, routers, WAPs, terminals and other electronic devices that may include some form of processing capability.

Computing module 600 may include, for example, one or more processors, controllers, control modules, or other processing devices, such as a processor 604. Processor 604 may be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally. The bus 602 may also be connected to other components such as a display, input devices, or cursor control to help facilitate interaction and communications between the processor and/or other components of the computing module 600.

Computing module 600 may also include one or more memory modules, simply referred to herein as main memory 606. For example, random-access memory (RAM) or other dynamic memory may be used for storing information and instructions to be executed by processor 604. Main memory 606 may also be used for storing temporary variables or other intermediate information during execution of instructions to be executed by processor 604. Computing module 600 may likewise include a read only memory (“ROM”) or other static storage device 610 coupled to bus 602 for storing static information and instructions for processor 604.

Computing module 600 may also include one or more various forms of information storage devices 610, which may include, for example, a media drive 612 and a storage unit interface 620. The media drive 612 may include a drive or other mechanism to support fixed or removable storage media 614. For example, a hard disk drive, a floppy disk drive, a magnetic tape drive, an optical disk drive, a CD, DVD or Bluray drive (R or RW), or other removable or fixed media drive 612 may be provided. Accordingly, storage media 614 may include, for example, a hard disk, a floppy disk, magnetic tape, cartridge, optical disk, a CD or DVD, or other fixed or removable medium that is read by, written to or accessed by media drive 612. As these examples illustrate, the storage media 614 can include a computer usable storage medium having stored therein computer software or data.

In alternative embodiments, information storage devices 610 may include other similar instrumentalities for allowing computer programs or other instructions or data to be loaded into computing module 600. Such instrumentalities may include, for example, a fixed or removable storage unit 622 and a storage unit interface 620. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 600.

Computing module 600 may also include a communications interface 624 or network interface(s). Communications or network interface(s) interface 624 may be used to allow software and data to be transferred between computing module 600 and external devices. Examples of communications interface or network interface(s) may include a modem or soft modem, a network interface (such as an Ethernet, network interface card, WiMedia, WiFi, IEEE 802.XX or other interface), a communications port (such as for example, a USB port, IR port, RS232 port Bluetooth® interface, or other port), or other communications interface. Software and data transferred via communications or network interface(s) may typically be carried on signals, which can be electronic, electromagnetic (which includes optical) or other signals capable of being exchanged by a given communications interface. These signals may be provided to communications interface via a channel 626. This channel may carry signals and may be implemented using a wired or wireless communication medium. Some examples of a channel may include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 606, ROM, and storage unit interface 620. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing module 600 to perform features or functions of the present application as discussed herein.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, C, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “may,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computing system, comprising:
a boot firmware memory comprising a firmware image;
a host processor configured to access the boot firmware memory during a boot process of the computing system using the firmware image;
a management controller;
an auxiliary storage accessible to the management controller, the auxiliary storage comprising a recovery firmware image; and
a switchable communication path coupled to the boot firmware memory, the host processor, and the management controller;
wherein the management controller is configured to:
in response to a boot failure of the computing system during the boot process, control the switchable communication path and write the recovery firmware image from the auxiliary storage into the boot firmware memory to recover the computing system.

2. The computing system of claim 1, wherein to recover the computing system, the management controller is configured to:
actuate the switchable communication path to switch access to the boot firmware memory from the host processor to the management controller;
write the recovery firmware image from the auxiliary storage to the boot firmware memory;
restore access to the boot firmware memory to the host processor via the switchable communication path; and
cause the computing system to restart such that the host processor boots using the recovery firmware image written to the boot firmware memory.

3. The computing system of claim 1, wherein the auxiliary storage is inaccessible directly by the host processor.

4. The computing system of claim 1, wherein the switchable communication path is configured to selectively couple the management controller to the boot firmware memory such that the management controller writes the boot firmware memory using the recovery firmware image stored in the auxiliary storage.

5. The computing system of claim 1, wherein the auxiliary storage comprises a hot-pluggable storage medium.

6. The computing system of claim 1, wherein the management controller comprises a local memory, and
wherein to write the recovery firmware image from the auxiliary storage to the boot firmware memory, the management controller is configured to:
read the recovery firmware image from the auxiliary storage into the local memory; and
write the recovery firmware image from the local memory to the boot firmware memory.

7. The computing system of claim 6, wherein the management controller is further configured to:
enable an access channel between the host processor and the local memory, allowing the host processor to read the recovery firmware image directly from the local memory to boot the computing system.

8. The computing system of claim 7, wherein the booting of the computing system by the host processor using the recovery firmware image from the local memory and the writing of the recovery firmware image from the local memory to the boot firmware memory occur in parallel.

9. The computing system of claim 1, wherein the management controller is further configured to:
detect the boot failure by evaluating one or more boot-progress indicators comprising a power-on self-test (POST) completion status, an observed POST code, or a watchdog timer timeout.

10. The computing system of claim 2, wherein the switchable communication path comprises a multiplexer, and
wherein actuating the switchable communication path comprises electrically isolating a host processor bus from the boot firmware memory and coupling a management controller bus to the boot firmware memory.

11. The computing system of claim 1, wherein the auxiliary storage and the boot firmware memory store different respective copies of firmware, the recovery firmware image in the auxiliary storage being used by the management controller to restore the firmware image in the boot firmware memory after the boot failure.

12. The computing system of claim 1, wherein the management controller is configured to:
verify the recovery firmware image written to the boot firmware memory by reading back data and comparing the read-back data with corresponding data of the recovery firmware image.

13. A method of recovering boot firmware in a computing system, the computing system comprising a boot firmware memory storing a firmware image, a host processor, a management controller, an auxiliary storage accessible to the management controller and storing a recovery firmware image, and a switchable communication path coupled to the boot firmware memory, the host processor, and the management controller, the method comprising:
in response to a boot failure of the computing system during a boot process of the computing system, actuating, by a management controller, the switchable communication path to route access to the boot firmware memory from the host processor to the management controller;
writing, by the management controller, the recovery firmware image from the auxiliary storage to the boot firmware memory;
restoring, by the management controller, access to the boot firmware memory from the management controller to the host processor via the switchable communication path; and
causing, by the management controller, the computing system to restart such that the host processor boots using the recovery firmware image written to the boot firmware memory.

14. The method of claim 13, wherein the auxiliary storage is inaccessible directly by the host processor.

15. The method of claim 13, wherein actuating the switchable communication path comprises selectively coupling the management controller to the boot firmware memory such that the management controller rewrites the boot firmware memory using the recovery firmware image stored in the auxiliary storage.

16. The method of claim 13, wherein writing the recovery firmware image from the auxiliary storage to the boot firmware memory comprises:
reading, by the management controller, the recovery firmware image from the auxiliary storage into a local memory of the management controller; and
writing, by the management controller, the recovery firmware image from the local memory to the boot firmware memory.

17. The method of claim 13, further comprising:
detecting the boot failure by evaluating one or more boot-progress indicators comprising a power-on self-test (POST) completion status, an observed POST code, or a watchdog timer timeout.

18. The method of claim 13, further comprising verifying, by the management controller, the recovery firmware image written to the boot firmware memory by reading back data and comparing the read-back data with corresponding data of the recovery firmware image.

19. A management controller for use in a computing system comprising a boot firmware memory storing a firmware image, a host processor configured to access the boot firmware memory during a boot process of the computing system using the firmware image, an auxiliary storage storing a recovery firmware image, and a switchable communication path coupled to the boot firmware memory, the host processor, and the management controller, wherein the management controller is configured to:
in response to a boot failure of the computing system during the boot process, actuate the switchable communication path to route access to the boot firmware memory from the host processor to the management controller;
write the recovery firmware image from the auxiliary storage to the boot firmware memory;
restore access to the boot firmware memory from the management controller to the host processor via the switchable communication path; and
cause the computing system to restart such that the host processor boots using the recovery firmware image written to the boot firmware memory.

20. The management controller of claim 19, wherein the management controller comprises a local memory, and
wherein to write the recovery firmware image from the auxiliary storage to the boot firmware memory, the management controller is configured to:
read the recovery firmware image from the auxiliary storage into the local memory; and
write the recovery firmware image from the local memory to the boot firmware memory.
